(19) United States
(12) Patent Application Publication
(10) Pub. No.: US 2008/0121816 A1
(43) Pub. Date: May 29, 2008

(54) ULTRAVIOLET RADIATION GAUGE

(76) Inventor: Michael J. Ellig, Bozeman, MT (US)

Correspondence Address: HUSCH BLACKWELL SANDERS LLP, 4801 Main Street, Suite 1000, KANSAS CITY, MO, 64112, US

(21) Appl. No.: 11/563,273

(22) Filed: Nov. 27, 2006

(51) Int. Cl. G01N 21/00

(52) U.S. Cl. 250/474.1

(57) ABSTRACT

An ultraviolet radiation gauge is provided. The gauge includes a UV light sensing element that changes color in accordance with the amount of incident ultraviolet radiation. A scale element is provided for matching the color of the light sensing element. Indicia is provided to coordinate the matched color to an information chart that can provide instructions on actions to be taken depending upon the amount of sensed ultraviolet radiation.

### BACKGROUND OF THE INVENTION

Ultraviolet (UV) light (electromagnetic radiation) is both a necessity and a problem. Exposure to UV light needs to be controlled under certain circumstances, to prevent damage. For example, if one is sun tanning, excessive exposure to UV light, can result in serious burns and it has been attributed to certain forms of cancer as well as skin aging. UV light, has also been blamed for degradation, both structurally and esthetically of certain material for example, plastics, paints and upholstery, even when the materials are within an enclosure like a house, and a certain amount of the UV light is filtered by windows. Strides have been made in the latter circumstance, for improving both the structural life and the esthetic life of certain materials by providing enhanced UV filtering which may not be apparent.

UV light can be measured and predicted, but the common person has no readily available inexpensive means to detect the level of UV light in a certain environment at a certain time. For example, while tanning on the beach one may not realize the level of UV radiation incident on their skin which can lead to sunburns and other deleterious effects. Conditions may change throughout a period of exposure to UV light. In the case of tanning, various tanning lotions are available having differing levels of UV light protection. However, it may be difficult to determine which particular lotion to use or how much or how often to apply, since it is unknown what the level of incident radiation is which cannot necessarily be determined by the amount of sunlight that is visible. Exposing oneself on a cloudy day can sometimes result in a worse burn than on a sunny day because it is difficult to gauge ones exposure on a cloudy day when compared to a sunny day because of the difference in the heat from the sun as well as the UV radiation.

Additionally, UV radiation can deteriorate certain materials particularly, upholstery, rugs, some woods like walnut and the like. It would be desirable to know the level of incident UV radiation inside a home or the like in certain locations to determine the appropriate location of materials that are subject to degradation.

Thus, there is a need for an inexpensive UV radiation gauge that is simple to use inexpensive and accurate for the measurement of the incident UV radiation and, in addition, to provide reference indicia which can be coordinated to instructions to a user of the gauge.

### SUMMARY OF THE INVENTION

The present invention involves the provision of a UV radiation gauge that uses a light sensitive element operable to visually change, e.g., change color in accordance with the incident level of UV radiation. A scale element is provided and associated with the light sensitive element. The scale element has a plurality of fixed colors visible at a position adjacent the light sensitive element for comparing the respective colors thereof to determine the incident level of UV radiation level. Indicia is provided for at least some of the fixed colors for referencing an information chart to provide instructions to a person, for example, the frequency of application of sun tan lotion or could provide a usage or exposure warning.

### BRIEF DESCRIPTION OF THE DRAWINGS

FIG. 1 is a perspective view of a container which includes a UV light sensitive element, a scale element and indicia associated with the scale element.

FIG. 2 is an enlarged perspective view of a cap portion of the container which cap portion includes a UV light sensitive element and a scale element as well as reference indicia.

FIG. 3 is an elevation section view of the container of FIG. 1.

FIG. 4 is a perspective view of a modified form of the UV gauge system.

FIG. 5 is a perspective view of a tube form of container.

Like numbers throughout the various Figures designate like or similar parts and/or construction.

### DETAILED DESCRIPTION

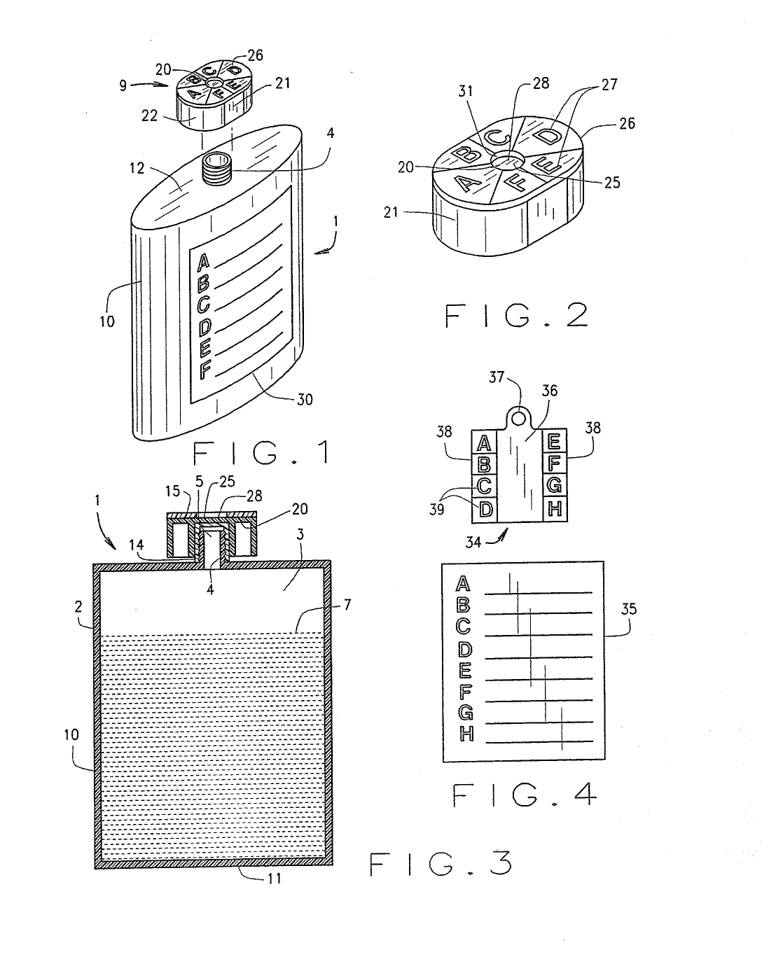

FIGS. 1-3 show a first form of a UV light gauge system. As shown, a container 1 is provided comprising a body 2 having a storage chamber 3 and an outlet such as a threaded neck 4 with a flow passage 5 therethrough, providing communication between the exterior of the container 1 and the chamber 3. The chamber 3 can contain contents 7 of choice like sun tan lotion. A UV gauge 9 is provided. The body 2 can include a sidewall 10, a bottom wall 11 and a top wall 12. The body 2 may be of an injection or blow molded type and can be made out of polymeric materials as polyethylene or polypropylene as is desired. Preferably, the sidewall 12 is flexible to allow squeezing thereof to assist in the dispensing of the contents 7. The container 1 as shown includes a cap which can include a sub-cap 14 and a cap 15. A sub-cap 14 may be provided for threaded engagement with the neck 4 to help seal the chamber 3. The container 1 also includes a UV light sensitive element such as cap 15 or portion of the cap 15. The cap 15 can be an overcap for the cap 14 and may be separatable from the cap 14 or the caps 14 and 15 can be combined in a unitary or integral structure. The cap 14 or 15 may be secured to the body 12 via a friction fit, snap lock engagement or a threaded engagement as is desired. For threaded engagement, the threads on the exterior of the neck 4 and the interior of the cap 14 or 15 can be indexed to provide for proper orientation of, particularly, the cap 15 relative to the body 2 in the event the cap 15 is not round in transverse cross section. The body 2 is shown as a bottle but could be a squeeze tube 1T with a closed end 13 as seen in FIG. 5. The tube 1T has a squeezable body 2T with a sidewall 12T. A cap 15 removably mounted to the tube 1T.

In the illustrated structure, the cap 15 has a top panel 20 and a depending sidewall 21. The panel 20 and sidewall 21 may be molded as an integral unit or bonded together as with adhesive. Securement of the cap 15 to a separately formed cap 14 can be by frictional engagement, snap lock engagement or adhesive engagement as is desired for the particular execution.

The container 1, as shown, includes a UV light sensitive element 25, a scale element 26 and indicia 27. In a preferred embodiment, the light sensitive element 25, scale element 26 and indicia 27 are part of the cap 15 and are mountable on the body 2 and selectively separable from the body 2 and preferably the cap 14 for convenience of use while still being able to maintain the contents 7 sealed in the chamber 3 by having the cap 14 remain secured to the neck 4.

An information chart 30 is preferably secured to the body 2 in a permanent or semi permanent manner as with adhesive or can be printed on the body 2. It is to be understood that the information chart 30 may be packaged for easy removal from the body 2 for example in an open sided pouch or may be attached to the cap 15 and movable relative to scale element 26.

As illustrated in FIG. 1, the scale element 26 is positioned on the top panel 20 and has a central opening 31 surrounding a portion 28 of the top panel 20 exposing the top panel 20 immediately adjacent the scale element 26 for convenience of color comparison. As used herein, “color” can be one or more of color which can be measured by the wavelength of the reflected or absorbed light for example red, green, blue and can include an intensity and/or density of the color, hue, shade, saturation and/or brightness for example, a gray scale or other color scale similar to a gray scale. What is important is that the “color” change in element 25 is perceivable and distinguishable by the eye. Preferably, the element 25 is photochromic. The opening 31 exposes a portion of the sensing element 25 inside of the opening 31 with the scale element being immediately adjacent and surrounding the portion 28 of the element 25 for ease of color comparison. Having a generally centrally located opening 31 is convenient since all of the different colors on the scale element 26 can be readily compared simultaneously with the element 25. The entirety of the cap 15 exclusive of the scale element 26 can be photochromic. Preferably, the element 25 is made of a polymeric material impregnated with a photochromic dye as are well known in the art. The photochromic dye is sensitive to UV radiation and will change color in a short period of time with a change in the intensity of the incident UV radiation. The scale element 26 includes the plurality of fixed colors visible for comparison adjacent the element 25 for comparing the respective colors thereof and thereby determine a degree of current incident UV radiation level. The scale as exemplified by the indicia A-F designated color zones may be arbitrary. By best matching the color of the element 25 to one of the fixed colors A-F, information regarding the level of incident UV radiation may be readily and easily determined. In a preferred embodiment, the scale element 26 may be a separate part secured to the panel 20 or may be printed in place on the panel 20 and still be adjacent. In an alternate embodiment, the scale element 26 can be mounted for example over the neck 4, secured to the body 2 or held in place by an interlocking engagement with portions of the neck and still be adjacent, needing only limited relative movement for side-by-side comparison. By viewing the cap 15 downwardly, the color of the element 25 can be readily compared to the colors at A-F on the scale element 26 providing an immediately adjacent relationship. While colors A-F are shown, any suitable number may be provided depending on how much color change can be effected or perceived in the light sensitive element 25 in the expected change of incident UV radiation, e.g., only colors A, B or A, B, C may be needed.

The container 1 can also include as an integral part or detachable part, or as part of an outer package, an information chart 30. The information chart 30 may be incorporated into the scale element 26. The information chart 30 has information coordinated to each of the colors A-F. By determining which of the colors on the scale element best matches the sensing element 25, the appropriate instruction as listed on the information chart 30 can be ascertained by a user to determine the appropriate course of action. For example, if the color A matches the color of the element 25, the A instruction could be to apply lotion once every two hours. If a high degree of incident UV radiation is detected, that may be indicated by the color F matching the element 25 and that may provide an instruction for applying the lotion once every ten minutes or even perhaps provide a warning such as leave the area where the UV radiation is incident to. In an alternate embodiment, the element 25 may be removable from the body 2 and the scale element 26 may be part of the information chart 30 and the element 25 may be moved immediately adjacent to the scale element 26 to determine which color matches the element 25 and then determine which is the appropriate instruction A-F on the instruction chart 30 for the current level of incident UV radiation. The element 25 may be part of the body 2, e.g., an integral part of the body 2. The body 2 may also be made up entirely or substantially entirely of photochromic material.

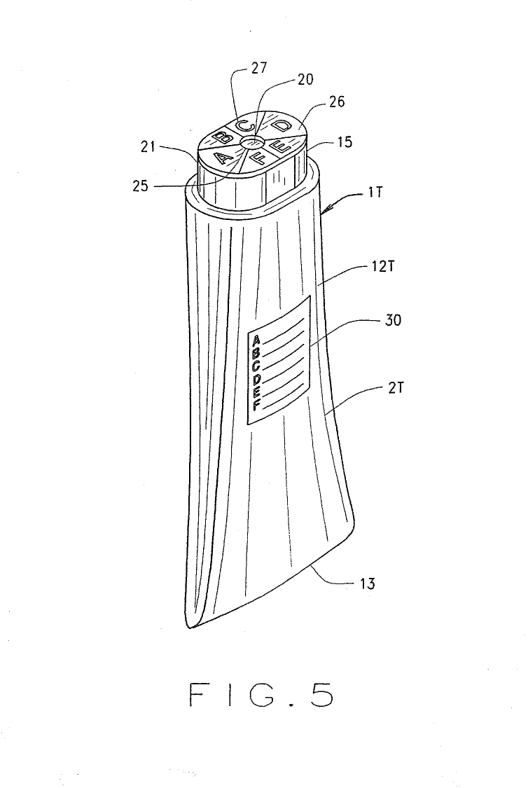

FIG. 4 shows another alternate embodiment of a gauge 34 with a UV sensing element 36 like the element 25 described above, that can be easily carried, for example, in one's pocket, brief case or tool kit to utilize in an area to simply determine the degree of incident UV radiation. Different information charts 35 may be provided, for example, an information chart 35 may be provided for carpet, one for paint, one for upholstery and the like. The user may then select the appropriate chart 35 and by doing a best color match on a gauge 34, by matching a color on a scale element 38 with comparative colors and indicia 39 which are shown as two separate strips one on each side of the sensing element 36, the appropriate instruction can be determined from the chart 35. A lanyard hole 37 may be provided to assist in finding or carrying the gauge 34. The scale element 38 may be permanently secured to the sensing element 36 as by an adhesive engagement. The sensing element 36 is preferably polymeric infused with photochromic dye. The scale element 38 has fixed colors as does the scale element 26. The indicia 39 may be printed on the scale elements 38 and denoted by references A-H, e.g. Additionally, the scale elements 38 may be made a part of the information chart with the photochromic element 36 being movable to a fixed colored portion on the information chart 35 to determine the best color match.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations, and other uses and applications of the present construction will, however, become apparent to those skilled in the art after considering the specification and the accompanying drawings.

1. A UV radiation gauge comprising;
a light sensing element operable to change color in accordance with a change in a level of incident UV radiation;
a scale element positioned adjacent said light sensing element, said scale element having a plurality of fixed colors visible for comparing the respective colors thereof to the light sensing element and thereby determine current incident UV radiation level; and
indicia associated with the scale element for at least some of the fixed colors.

2. The gauge as set forth in claim 1 wherein the light sensing element has at least a portion thereof positionable immediately adjacent the scale element, said light sensing element including a photochromic portion.

3. The gauge as set forth in claim 2 wherein the light sensing element and scale element are part of a container.

4. The gauge as set forth in claim 3 wherein the photochromic portion is part of a container cap.

5. The gauge as set forth in claim 4 wherein the scale element is mounted to the light sensing element.

6. The gauge as set forth in claim 3 wherein the container includes contents and an information chart containing information on how to use the contents in accordance with the amount of current incident UV as indicated by the scale element.

7. The gauge as set forth in claim 6 wherein the container contains sun screen lotion.

8. The gauge as set forth in claim 6 wherein the scale element is mounted to the light sensing element,

9. The gauge as set forth in claim 6 wherein the container includes a body with a storage chamber and the scale element is mounted to the body.

10. The gauge as set forth in claim 9 wherein the body having a squeeze tube portion.

11. The gauge as set forth in claim 9 wherein the photochromic portion being part of the body.

12. The gauge as set forth in claim 6 wherein the information chart is mounted to the body and includes information regarding the use of the contents in accordance with an indicated level of incident UV radiation.

13. The gauge as set forth in claim 1 wherein the scale element is mounted to the light sensing element.

14. The gauge as set forth in claim 13 including an information chart coordinated with the indicia and providing instructions for accommodating a measured level of incident UV radiation.
